(19) United States
(12) Patent Application Publication
(10) Pub. No.: US 2012/0217881 A1
(43) Pub. Date: Aug. 30, 2012

(54) ILLUMINATION SYSTEMS WITH NATURAL AND ARTIFICIAL LIGHT INPUTS

(75) Inventors: Gaurav Sethi, Dublin, CA (US); James Chester Meador, Berkeley, CA (US); Jonathan Charles Griffiths, Fremont, CA (US); David William Burns, San Jose, CA (US)

(73) Assignee: QUALCOMM MEMS Technologies, Inc., San Diego, CA (US)

(21) Appl. No.: 13/291,012

(22) Filed: Nov. 7, 2011

Related U.S. Application Data
(60) Provisional application No. 61/447,565, filed on Feb. 28, 2011.

(51) Int. Cl. H05B 37/02

(52) U.S. Cl. 315/155

(57) ABSTRACT

This disclosure provides systems, methods, and apparatus for illumination systems with natural and artificial light inputs. In one aspect, an apparatus can include a natural light collection system, an artificial light collection system, an illumination panel, and a control system. The illumination panel can be optically coupled to the natural light collection system and the artificial light collection system to receive natural and artificial light. The control system can be coupled to the artificial light system and can be configured to control the artificial light system.

### CROSS-REFERENCE TO RELATED APPLICATIONS

This disclosure claims priority to U.S. Provisional Patent Application No. 61/447,565, filed Feb. 28, 2011, entitled “ILLUMINATION SYSTEMS WITH NATURAL AND ARTIFICIAL LIGHT INPUTS,” and assigned to the assignee hereof. The disclosure of the prior application is considered part of and is incorporated by reference in this disclosure.

### TECHNICAL FIELD

This disclosure relates to the field of illumination, and in particular, to illumination systems including natural and artificial light inputs.

### DESCRIPTION OF THE RELATED TECHNOLOGY

A variety of architectural lighting configurations are utilized to provide illumination in a wide variety of indoor and/or outdoor locations. Such illumination systems can include fixed and portable architectural lighting. Various configurations can employ technologies such as incandescent, fluorescent, and/or light emitting diode based light sources.

One type of architectural lighting configuration can be referred to generally as panel lighting. Panel lights may include, for example, fluorescent lighting in a light box behind a plastic lenticular panel. Panel lighting is often configured as planar and square or rectangular and having width and length dimensions significantly greater than a thickness dimension. While the thickness of panel lighting is generally significantly less than corresponding width and length dimensions, it is frequently the case that the thickness of existing panel lighting forces limitations in installation and use.

One specific type of panel lighting is flat panel lighting. Flat panel lights are commonly found in flat panel display applications, which include a transparent panel designed to provide illumination from its planar surface. Light is provided into the panel from a light source (e.g., LEDs or a CCFL lamp), which may be positioned along one or more edges of the panel. Light travels throughout the panel, staying within the panel due to total internal reflection at its front planar surface and back planar surface. At some places on the panel, light may be directed out of the panel by a light extraction or turning feature.

In architectural lighting configurations, artificial light sources are typically the sole source(s) of light for a light panel.

### SUMMARY

The systems, methods, and devices of the disclosure each have several innovative aspects, no single one of which is solely responsible for the desirable attributes disclosed herein.

One innovative aspect of the subject matter described in this disclosure can be implemented in an illumination system including a natural light collection system, an artificial light system, an illumination panel, and a control system. The illumination panel includes a first light input port that is optically coupled to the natural light collection system and a second light input port that is optically coupled to the artificial light system. The illumination panel receives natural light from the natural light collection system through the first light input port and receives artificial light from the artificial light system through the second light input port. The illumination panel also includes a light output port. The control system includes at least one data input port and is coupled to the artificial light system. The control system is configured to control a characteristic of the artificial light based on at least one signal received by the at least one data input port.

In one aspect, the illumination panel can include a first surface, a second surface opposite the first surface, a first edge disposed between the first surface and the second surface, and a second edge disposed between the first surface and the second surface. In one aspect, the first edge can include the first light input port. In one aspect, the first edge can include the second light input port. In another aspect, the second edge can include the second light input port. In one aspect, the second edge can be disposed on an opposite side of the illumination panel than the first edge. In another aspect, the second edge can be disposed orthogonal to the first edge. In one aspect, the first surface can include the second light input port. In another aspect, the first surface can include the first light input port and the first surface can include the second light input port.

In one aspect, a light that passes through the output port can include at least a portion of the natural light. In another aspect, the light that passes through the output port can include at least a portion of the artificial light. In one aspect, a light that passes through the output port can include at least a portion of the natural light and at least a portion of the artificial light. In one aspect, the control system can receive the at least one signal from the natural light collection system. The at least one signal can correspond to a color characteristic of the natural light. The control system can control a color characteristic of the artificial light. In one aspect, the at least one signal can correspond to an intensity characteristic of the natural light. The control system can control an intensity characteristic of the artificial light. In one aspect, the control system can receive the at least one signal from the illumination panel. The at least one signal can correspond to a color characteristic of the natural light. In one aspect, the control system can control a color characteristic of the artificial light. The at least one signal can also correspond to an intensity characteristic of the natural light and the control system can control an intensity characteristic of the artificial light. In another aspect, the illumination panel can include a plurality of light extraction features configured to extract light propagating within the panel into the light output port. In one aspect, the natural light collection system can include a light guide having a plurality of light gathering features.

One innovative aspect of the subject matter described in this disclosure can be implemented in a method including providing an illumination system including a natural light collection system, an artificial light system, and an illumination panel configured to receive natural light from the natural light collection system and artificial light from the artificial light system. The illumination panel is also configured to emit an output light. The method also includes receiving a first characteristic of the natural or the artificial light and adjusting a second characteristic of the artificial light based at least in part on the first characteristic.

In one aspect, the first characteristic can correspond to a color of the natural light and the second characteristic can correspond to a color of the artificial light. In another aspect, the first characteristic can correspond to an intensity of the natural light and the second characteristic can correspond to an intensity of the artificial light. In one aspect, the first characteristic can correspond to a color of the output light and the second characteristic can correspond to a color of the artificial light. In another aspect, the first characteristic can correspond to an intensity of the output light and the second characteristic can correspond to an intensity of the artificial light. In one aspect, the method can include receiving a third characteristic. In another aspect, the method can include adjusting a fourth characteristic of the artificial light based at least in part on the third characteristic.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a system diagram of an illumination system with natural and artificial light inputs.

FIG. 2A shows a perspective view of an example of an illumination panel with natural and artificial light inputs.

FIG. 2B shows a side view of the illumination panel of FIG. 2A.

FIG. 3A shows a perspective view of an example of an illumination panel with natural and artificial light inputs.

FIG. 3B shows a side view of the illumination panel of FIG. 3A.

FIG. 4A shows a perspective view of an example of an illumination panel with natural and artificial light inputs.

FIG. 4B shows a side view of the illumination panel of FIG. 4A.

FIG. 4C shows another side view of the illumination panel of FIG. 4A.

FIG. 5A shows a perspective view of an example of a natural light collection system that can be incorporated in an illumination system with, for example, the illumination panels illustrated in FIGS. 1-4C.

FIG. 5B shows a side view of the natural light collection system of FIG. 5A.

FIG. 5C shows a side view of an example of an illumination system including the natural light collection system of FIG. 5B and an illumination panel.

FIG. 6A shows a perspective view of a natural light collection system optically coupled to an illumination panel in an example of an illumination system.

FIG. 6B shows a side view of the illumination system of FIG. 6A.

FIG. 7A shows a perspective view of an example of an illumination system with natural and artificial light inputs.

FIG. 7B shows a side view of the illumination system of FIG. 7A.

FIG. 8 shows a side view of an example of a natural light collection system of an illumination system.

FIG. 9 shows an example of a system diagram of an illumination system with a natural light input, an artificial light input, and a control system that can vary the artificial light input based at least in part on the natural light input.

FIG. 10A shows an example timing diagram for balancing inputs of light in an illumination system with natural and artificial light inputs.

FIG. 10B shows an example flow diagram of a process for balancing inputs of light in an illumination system with natural and artificial light inputs.

FIG. 11A shows an example timing diagram for balancing inputs of light in an illumination system with natural and artificial light inputs.

FIG. 11B shows an example flow diagram of a process for balancing inputs of light in an illumination system with natural and artificial light inputs.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. For example, features included in an example architectural illumination system can also be included in a non-architectural illumination system. It will be appreciated that the illustrated systems are not necessarily drawn to scale and that their relative sizes can differ. Thus, the teachings are not intended to be limited to the implementations depicted solely in the Figures, but instead have wide applicability as will be readily apparent to a person having ordinary skill in the art.

Architectural lighting can be used to provide artificial illumination in a wide variety of indoor and/or outdoor locations. Such illumination systems can include fixed and/or portable architectural lighting. Various configurations can include, for example, incandescent, metal halide, fluorescent, compact fluorescent, halogen, xenon, and/or light emitting diode (“LED”) based light sources. Panel lighting may be configured as planar and square or rectangular and having width and length dimensions that are each significantly greater than a thickness dimension. In some implementations, panel lighting is configured as non-planar and/or curvilinear. Flat illumination panels can be sized for luminaire or architectural applications. For architectural applications, a panel may be up to about 4′×8′ or more, or made of tiles of smaller dimensions. The panel can include different materials including glass and/or polymers, for example, acrylic, polyethylene terephthalate, and/or polycarbonate. A 4′×8′ panel may require a thickness of about 0.25″ or greater to allow adequate transmission of light along its width when illuminated from two edges.

Various implementations disclosed herein include an illumination panel that is optically coupled with at least one artificial light system and at least one natural light collection system. As discussed in further detail below, the illumination panel can receive and output natural light along with artificial light. An “artificial light system,” as used herein is a broad term, and refers to any light system that produces light without using sunlight or other natural source of ambient light. Some examples of artificial light systems include incandescent, LED, fluorescent of any type including compact fluorescent, halogen, and/or xenon light sources. A natural light collection system as used herein refers to a system that is configured to collect natural light (which typically originates from the sun) and provides at least a portion of the collected light to a lighting output surface or device, for example, an illumination panel. A natural light collection system can include collection lenses and housings, optical redirecting features, light guides, ducting having inner reflective surfaces, and other collection and optical devices to provide natural light from an input location to an illumination panel, typically located inside a building and some distance from the input location. Illumination systems that include a natural light collection system can reduce overall lighting costs and energy consumption by using natural light as a substitute for, and/or to supplement, artificial light provided by the one or more artificial light systems.

The illumination system can also include a control system configured to automatically control illumination provided by the illumination system. The control system can be configured to control and/or adjust a characteristic of artificial light that is emitted from the at least one artificial light system, for example, the intensity of the emitted light such as off, on, or a brightness level, and/or a light color characteristic such as component levels of red, green, blue, or white light. The control system can be configured to receive information through a signal or data port (e.g., data or signals) that can be used to influence the output of the illumination system, as controlled by the control system. The information can include user lighting preferences indicating a desired illumination, for example, when a room is occupied or vacant. The information can also include lighting preferences that comply with building or company preferences. In another example, the control system can receive information from a sensor, and may control an artificial light system output based at least in part on the received information. In some implementations of illumination systems, the control system is configured to control the intensity and/or color of light emitted from the artificial light system based on the intensity and/or color of natural light provided by the natural light collection system. In some implementations, the control system may control the intensity and/or color of artificial light emitted from the artificial light system based on the intensity and/or color of light that is output from an illumination panel that is optically coupled to a natural light collection system and an artificial light system. In some implementations, the control system may include a switch such as a light switch or a wall switch positioned on or near the illumination panel that turns the artificial light system on or off as a user turns the switch on or off. The light switch or wall switch may further include dimming circuitry to allow a user to dim or brighten the light level of the artificial light. The switch may further include motion detection circuitry that can determine when a user is near the illumination panel and turn or keep the artificial light on accordingly.

Particular implementations of the subject matter described in this disclosure can realize one or more of the following potential advantages. For example, illumination systems including at least one artificial light system and at least one natural light collection system can reduce energy consumption and lighting costs by supplementing and/or replacing artificial light with natural light when available. Further, variances, inconsistencies, and/or deficiencies in natural light available for a natural light collection system at a given time may be offset by an optional control system configured to adjust at least one characteristic of light emitted from an artificial light system based at least in part on a characteristic of the available natural light. Accordingly, the illumination systems disclosed herein can reduce energy consumption and lighting costs while maintaining one or more desired characteristics of light that is output from the system.

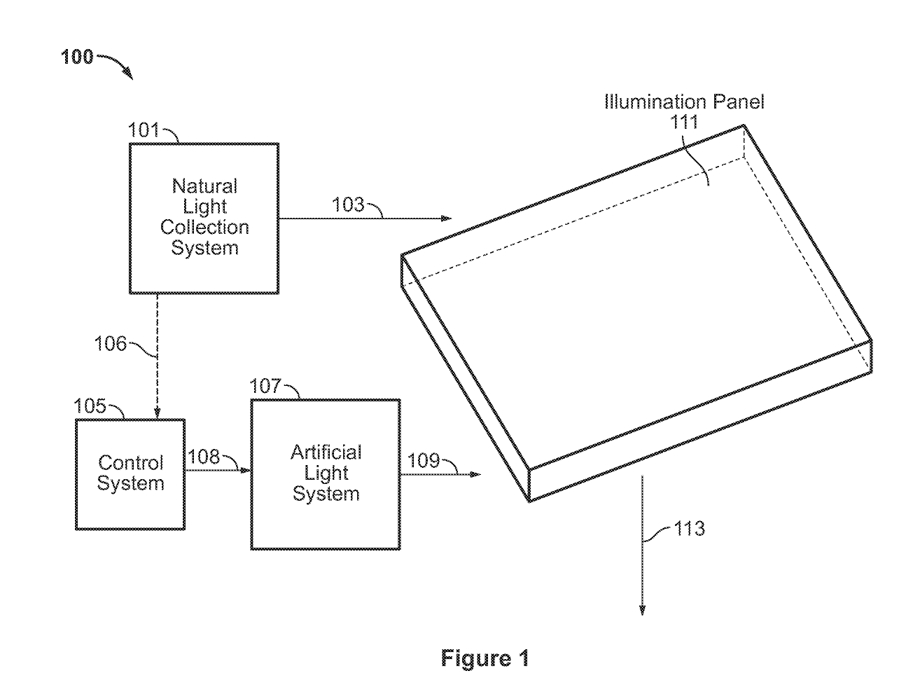

FIG. 1 shows an example of a system diagram of an illumination system with natural and artificial light inputs. The illumination system 100 can include an illumination panel 111 that is optically coupled to a natural light collection system 101, and further optically coupled to an artificial light system 107. The artificial light system 107 can include one or more artificial light sources (for example, an LED and/or fluorescent light source) and can provide artificial light 109 to the illumination panel 111 through one or more input ports on the illumination panel. Additionally, the natural light collection system 101 can provide natural light 103 to the illumination panel 111 through one or more input ports on the illumination panel. The illumination panel 111 can provide illumination output light 113, through one or more output ports (e.g., a planar surface of the illumination panel 111, where the output light 113 is based on the natural light 103 and the artificial light 109 that is received from the natural light collection system 101 and the artificial light system 107, respectively. As used herein, an “input port” refers to a surface, edge, portion, or region of an illumination panel that can receive light therethrough such that the received light enters the illumination panel 111. An “output port” refers to a surface, edge, portion, or region of an illumination panel that can emit light therethrough.

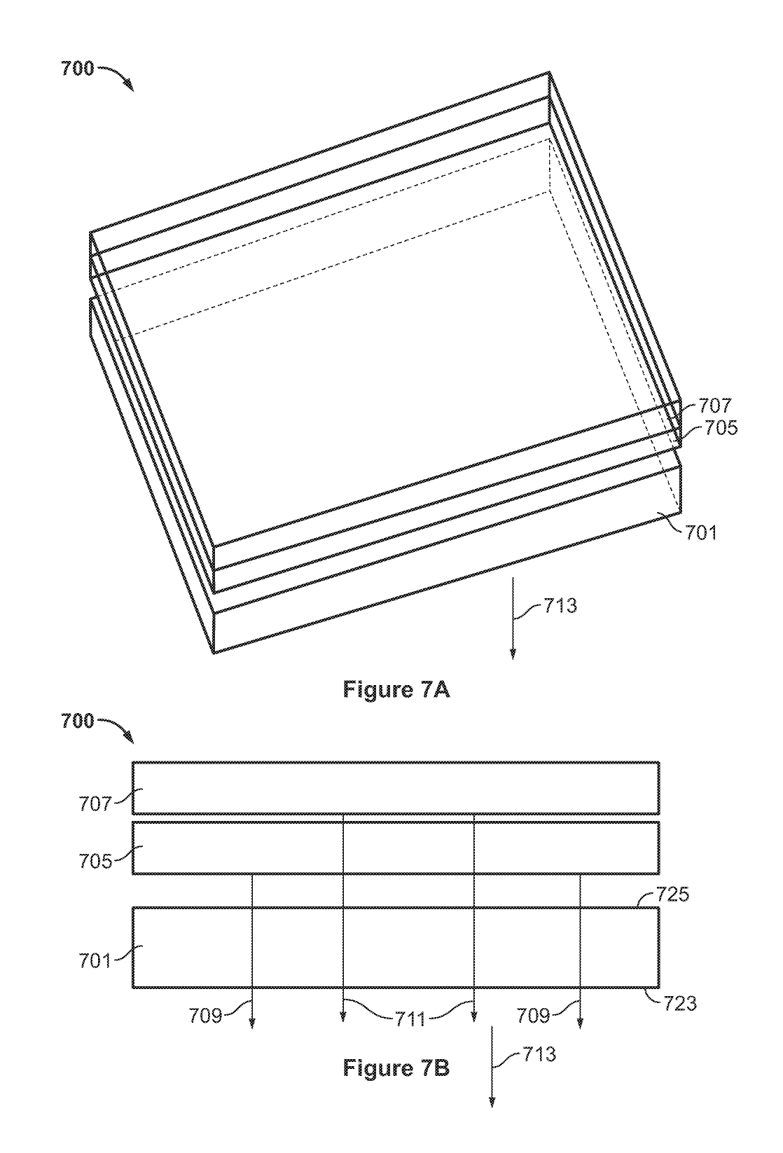

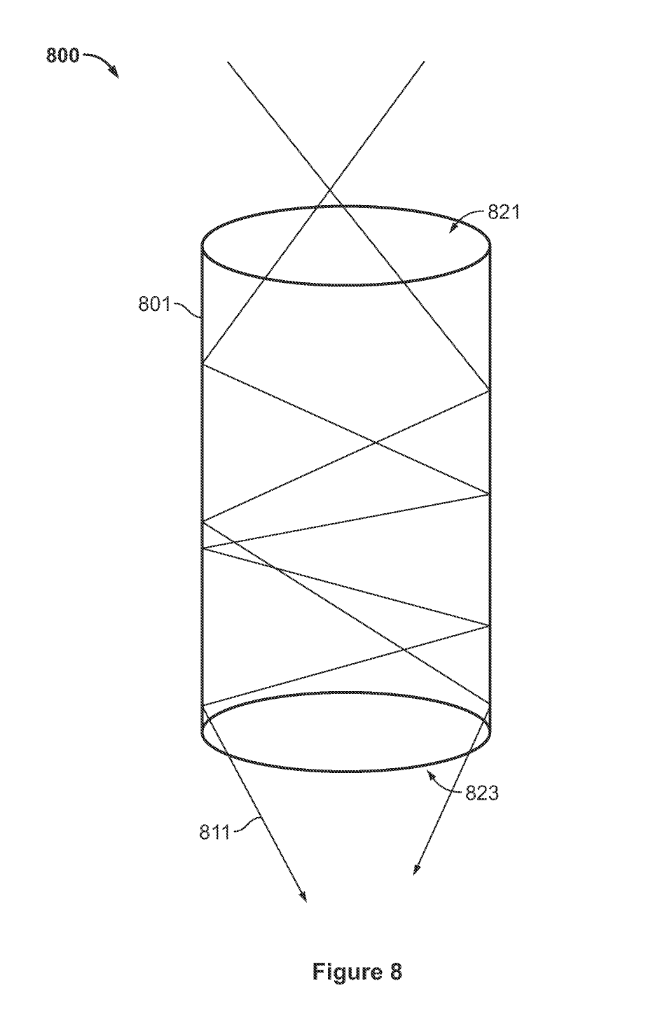

In some implementations, the illumination panel 111 can be a wave guide or light guide that has one or more edges which are configured as input ports. An input port can include an antireflective coating and be structured to optically couple with the natural light collection system 101 or the artificial light system 107. Natural light 103 and/or artificial light 109 that is provided into the input ports of the illumination panel 111 at least partially propagates in the illumination panel 111 by total internal reflection. In some implementations, surfaces and edges of illumination panels that are not configured as input ports or output ports can have a reflective or absorptive coating to prevent light from leaking out of the illumination panel 111 at undesired locations. In such implementations, the illumination panel 111 can include one or more light turning or light extraction features to cause light propagating therein to exit the illumination panel 111 in a desirable manner, for example, through one or more exit ports or surfaces. In some implementations, the illumination panel 111 is generally rectangular and includes edge portions and two planar surface portions disposed on opposite sides of the illumination panel 111. In some implementations, the illumination panel 111 is configured to receive at least some natural or artificial light through an edge of the illumination panel 111 and another portion of natural or artificial light through the same edge or through another edge of the illumination panel 111. In some implementations, the illumination panel 111 is configured to receive at least some light through an edge of the illumination panel 111 and another portion of light through one of the surfaces of the illumination panel 111. In these implementations, the illumination panel 111 is configured such that light that is provided through one edge of the illumination panel 111 can be guided through the illumination panel 111 and be turned or extracted by one or more light turning or light extraction features, while light entering a surface of illumination panel 111 can pass directly through with minimal diminishment. In other implementations, both natural and artificial light are provided to a surface of the illumination panel 111 and pass through the illumination panel 111 (see e.g., FIG. 7).

The natural light collection system 101 can include a system that collects natural ambient light such as direct sunlight of any wattage and/or lumen output and directs at least a portion of the collected natural light 103 to the illumination panel 111. Natural light that is available for collection by the natural light collection system 101 may be inconsistent throughout the day. Natural light may also vary in color depending on the time of day, weather, and/or atmospheric conditions. For example, natural light may be unavailable at night, and available natural light may appear more red or yellow at dusk. Additionally, the directionality of available natural light changes continuously in daily and annual cycles which can affect characteristics of the natural light, including intensity and color.

In some implementations, the effects of intensity variance, directional variance, inconsistency, and/or color of the natural light 103 on the output light 113 can be controlled or adjusted by a control system 105 that can be coupled to the artificial light system 107 through a communication link 108. The control system 105 is configured to control and/or adjust one or more characteristics of the artificial light 109. For example, in some implementations the control system 105 can adjust a light intensity characteristic and/or a color characteristic of the artificial light 109 via the communication link 108. In some implementations, the control system 105 can include one or more ports that receive information (e.g., data or signals) related to light collected in the natural light collection system 101, from a user indicating lighting preferences, and/or from a sensor sensing light output from the illumination panel 111. For example, the control system 105 can receive a signal from the natural light collection system 101 through a communication link 106. Implementations of the communication links 106 and 108 for coupling two or more systems together can include one or more of a wireless link, at least one wire for an electrical communication link, or at least one optical fiber for an optical communication link, and suitable interface components. The received signal can be related to a characteristic (e.g., intensity or color) of light collected in the natural light collection system 101. The control system 105 is configured to control and/or adjust one or more characteristics of the artificial light 109 based at least in part on the information received. For example, in one implementation the control system 105 can receive information relating to a color and/or intensity characteristic of the natural light 103. The control system 105 includes circuitry to process this data and adjust or control a color and/or intensity characteristic of the artificial light 109 based on the received information such that the artificial light 109 and the output light 113 possess one or more desired characteristics, for example, a color and/or an intensity. In this way, controlled illumination from the illumination panel 111 can be enabled through a selective combination of the natural light 103 and the artificial light 109. Also, by monitoring the natural light, the use of the artificial light 109 can be limited to supplement the natural light 103 to reduce energy consumption and costs. Thus, the control system 105 can be used to control the effects of the characteristics of the natural light 103 on the output light 113.

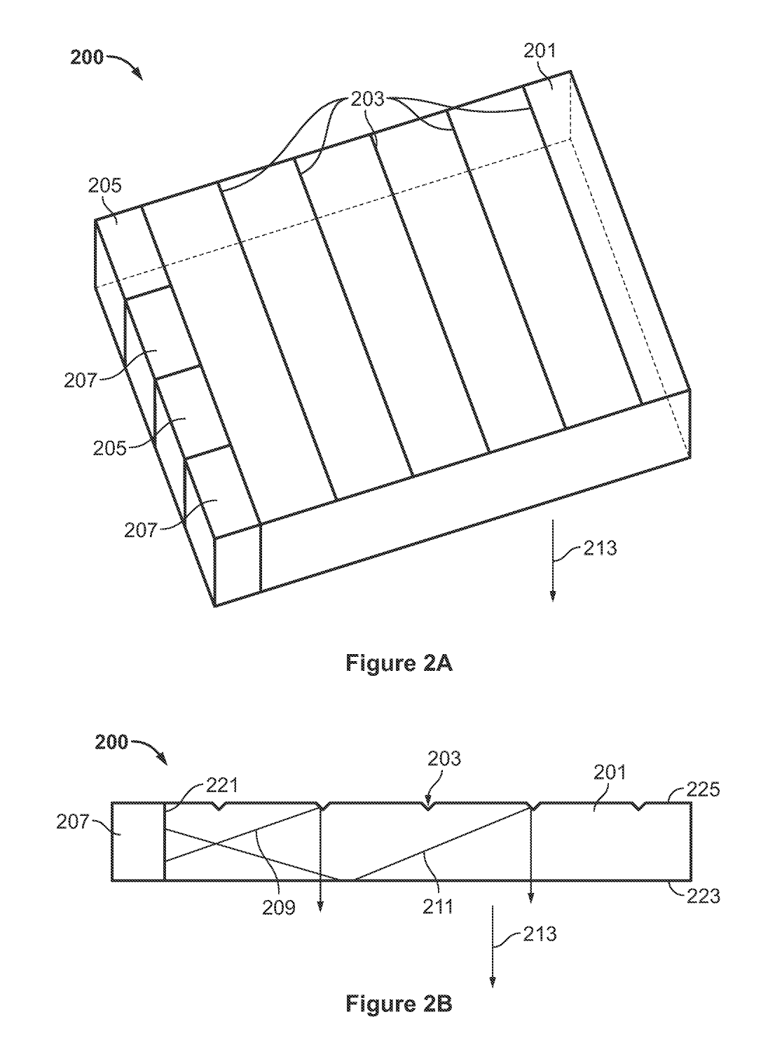

FIG. 2A shows a perspective view of an example of an illumination panel with natural and artificial light inputs. The illumination panel 201 includes edge portions that can be coupled to natural and artificial light input structures. FIG. 2B shows a side view of the illumination panel of FIG. 2A. The illumination panel 201 is configured to emit light 213 in one or more directions. As illustrated in FIG. 2A, a plurality of input ports of the illumination panel 201 can be optically coupled to a plurality of output ports of one or more natural light collection systems 207 and to a plurality of output ports of one or more artificial light systems 205. In this implementation, the output ports of the natural and artificial light systems are disposed along an edge of the illumination panel 201, in an alternating arrangement. As illustrated in FIGS. 2A-B, 3A-B, 4A-B, 6A-B and 7A-B, the natural light collection and the artificial light systems, which can be complex, are merely schematically depicted so as to not obscure this disclosure when describing the way these systems optically couple with the illumination panel. For example, the natural light collection system can include large collection ports and complex waveguides to provide suitable light. Similarly, an artificial light system can include complex (or simple) arrangements of numerous light sources. In some implementations, the illumination system 200 can include two or more natural light collection systems and two or more artificial light collection systems. In some implementations, the natural light and the artificial light can be injected along one edge of illumination panel 201 through two or more interleaved ports. The artificial light systems 205 can include one or more sources of artificial light, for example, one or more LEDs or fluorescent light sources, and can output artificial light 209 into the illumination panel 201 through an edge 221 of the illumination panel 201. The natural light collection systems 207 can collect natural light and output a portion of the natural light 211 into the illumination panel 201 through the edge 221 of the illumination panel 201.

With continued reference to the examples in FIGS. 2A and 2B, the illumination panel 201 includes an optically transmissive material that can be substantially optically transmissive at visible wavelengths. In some implementations, the illumination panel 201 can include a substantially optically transmissive sheet or film and may be planar or curved. In some implementations, the illumination panel 201 may include a substantially hollow center where air or other gas(es) serves as the primary light transmission medium. In some implementations, the illumination panel 201 can include more than one layer or film. For example, an array of regularly or irregularly spaced facets that serve as light-turning features can be coated locally with a thin metal layer such as aluminum or chrome to enhance the light-turning capability of the facets. In another example, the illumination panel 201 can include a stack of two or more layers and one or more optional thin films deposited over the stack. A holographic film, for example, can be disposed on one surface of an illumination panel 201 to turn light that is traversing the illumination panel 201. A thin metal layer or an absorber layer may be placed on the back of the holographic film or on the surface of the illumination panel 201 opposite the holographic film to further control the extraction of light. Illumination panel 201 can be coated on one or more sides with an anti-reflection coating or an index matching layer to control reflections. The illumination panel 201 can be formed from at least one rigid or semi-rigid material such as glass or acrylic so as to provide structural stability to the illumination system 200. In some other implementations, the illumination panel 201 can be formed of at least one flexible material such as a flexible polymer. Other materials, for example, polymethylmethacrylate, polyethylene terephthalate, or cyclo-olefin polymer may be used for the illumination panel 201 in other implementations. In some implementations, the illumination panel 201 may be formed of any material with an index of refraction that is greater than 1.0. In some implementations, the thickness of the illumination panel 201 can be between about 0.1 mm and 10 mm and the area of the upper surface 225 or lower surface 223 can be between about 1.0 cm² to 10,000 cm². However, dimensions outside these ranges are possible. For example, the panel size may be approximately 2.16 m×2.4 m, 2.88 m×3.13 m, or some fraction thereof. In some implementations, the upper surface 225 and the lower surface 223 of the illumination panel 201 may have approximately the same surface area. However, it is possible that they could be different in size and/or shape, for example, in implementations where one or more edges disposed between the upper and lower surfaces 225, 223 are slanted (e.g., not perpendicular to the upper and lower surfaces 225, 223). In some implementations, the upper surface 225 and the lower surface 223 can each be about 4′×8′ or other sizes such as 2′×4′, and they can be generally aligned parallel with one another. In some implementations, upper and lower surfaces 225, 223 are non-planar, forming a wedge.

Still referring to FIGS. 2A and 2B, in some implementations the natural light collection systems 207 and the artificial light systems 205 can be disposed along a common edge 221 of the illumination panel 201. An appropriate electrical power source can be coupled to the artificial light systems 205. Such power sources can include, but are not limited to, batteries, photovoltaic cells, fuel cells, generators, and/or an electrical power grid. The illumination system 200 can also include, but need not require switches, voltage control circuitry, current control circuitry, ballast circuits, and the like, arranged to operate the control system and the artificial light system 205. The power source and such optional control components of the illumination system 200 are not illustrated for clarity and ease of understanding of the components.

As schematically illustrated in the example of FIG. 2B, illumination panel 201 further includes light turning features 203 disposed on a surface of the illumination panel 201. Artificial light 209 and natural light 211 that is introduced into the illumination panel 201 may propagate through the illumination panel 201 until encountering light turning features 203, which are illustrated here as formed in the upper surface 225 of the illumination panel 201. When the artificial light 209 and the natural light 211 encounter a light turning feature 203, some of the light 209 and 211 may be turned toward the bottom surface 223 and emitted from the illumination panel 201 through the bottom surface 223. The light turning features 203 may include any feature configured to turn or extract light propagating within the illumination panel 201, for example, refractive features, dots, grooves, pits, truncated cones, prismatic features, holograms, or diffractive gratings. The light turning features 203 may be formed by a variety of techniques, including embossing or etching. Other techniques of forming the light turning features 203 may also be used. In some implementations, the light turning features 203 are formed or disposed on a film that forms a part of the illumination panel 201. In one implementation, the light turning features 203 include a plurality of elongated ridges or prism structures extending substantially across the upper surface 225 of the illumination panel 201. In another implementation, an illumination panel 201 includes light turning features 203 on both the upper surface 225 and the lower surface 223 to extract light from within the illumination panel 201 through the upper surface 225 and the lower surface 223. Any of the illumination panels described elsewhere in this disclosure can also have one or more of the above-described light-turning features.

Still referring to FIG. 2B, the artificial light 209 and the natural light 211 that are emitted from the lower surface 223 of the illumination panel 201 can form a composite output light 213. Characteristics of the output light 213, for example, color and/or intensity, can depend on the characteristics of the artificial light 209 and the natural light 211 that combine to form the output light 213. For example, in some implementations, a color characteristic of the output light 213 will be a combination of the color characteristics of the natural light 211 and the artificial light 209. Under some lighting conditions, the illumination panel 201 may not receive light from one of the natural light collection systems 207 or the artificial light systems 205. In these circumstances, the output light 213 includes only natural light 211 or artificial light 209. For example, when the intensity and/or color of the natural light 211 are sufficient for the purposes of the output light 213, a control system (such as the control system 105 depicted in FIG. 1) can control the artificial light system 205 output so that it provides a reduced amount of light or no light into the illumination panel 201. In such instances, energy consumption and lighting costs are reduced. The output light 213 may be directed in one or more directions to provide ambient or task lighting by, for example, a diffuser or a light directing device positioned at or near the output port of the illumination panel 201.

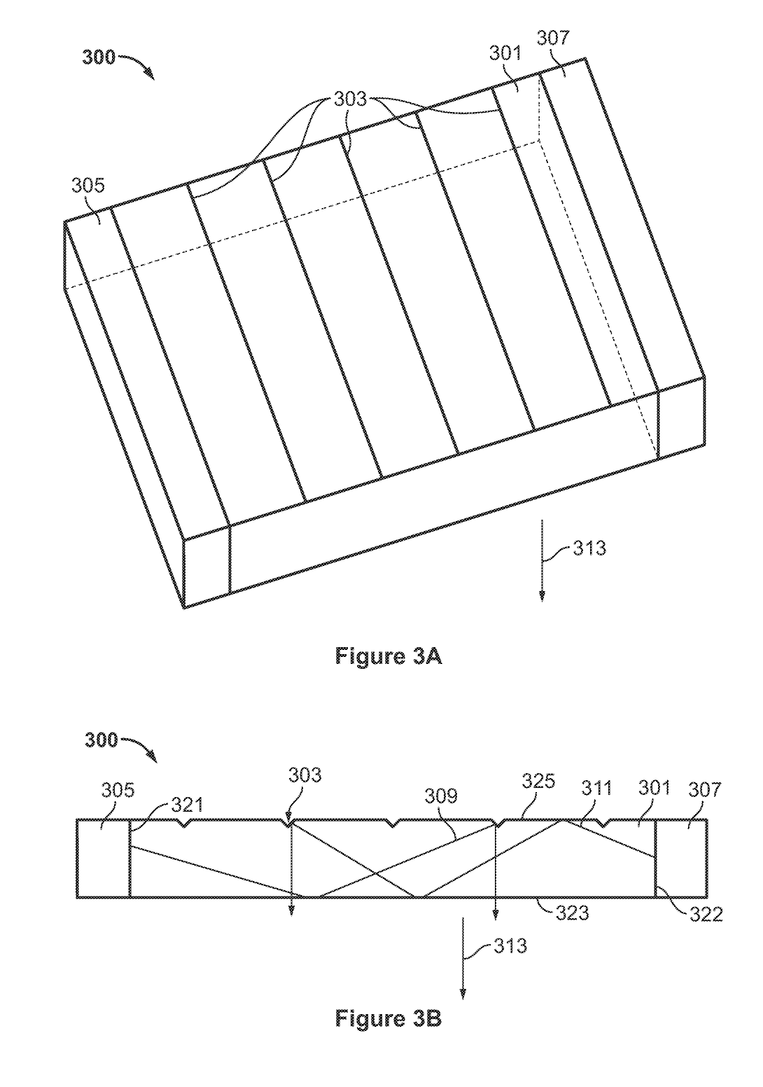

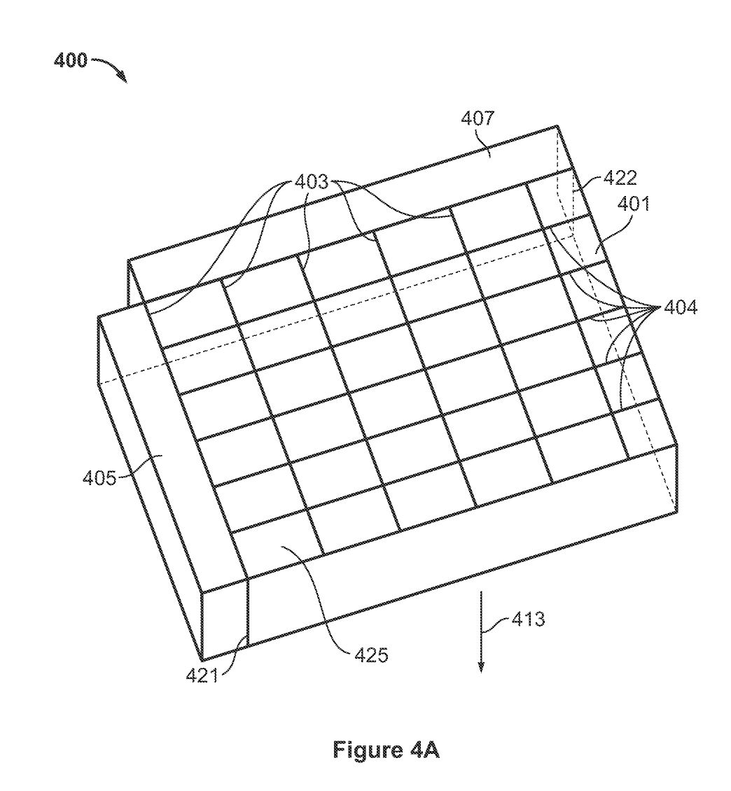

FIG. 3A shows a perspective view of an example of an illumination panel with natural and artificial light inputs. FIG. 3B shows a side view of the illumination panel of FIG. 3A. In some implementations, an illumination panel 301 is configured to emit an output light 313 in one or more directions. The illumination panel 301 can include similar materials and can be similarly sized and shaped to the illumination panel 201 discussed above with reference to FIGS. 2A and 2B. The illumination panel 301 can be optically coupled to one or more natural light collection systems 307 and to one or more artificial light systems 305.

In this example, the illumination system 300 includes an artificial light system 305 optically coupled to a first edge 321 of the illumination panel 301, and further includes a natural light collection system 307 optically coupled to a second edge 322 of the illumination panel 301, the first edge 321 disposed on an opposite side of the illumination panel 301 from the second edge 322. The artificial light system 305 can include one or more sources of artificial light, for example, one or more LED or fluorescent light sources, and can output artificial light 309 into the illumination panel 301 through the first edge 321 of the illumination panel 301. The natural light collection system 307 is configured to collect natural light and provide natural light into the illumination panel 301 through the second edge 321 of the illumination panel 301. Because the natural light 311 and the artificial light 309 are introduced into the illumination panel 301 through different edges (or input ports) of the illumination panel 301, the artificial light 309 is introduced into the illumination panel 301 without the artificial light system 305 physically obstructing the natural light 311 introduced by the natural light collection system 307 and vice versa.

As schematically illustrated in FIG. 3B, artificial light 309 provided through first edge 321 can propagate through the illumination panel 301 from the first edge 321 toward the second edge 322 and natural light 311 may propagate through the illumination panel from the second edge 322 toward the first edge 321. The artificial light 309 and the natural light 311 may be trapped within the illumination panel 301 by total internal reflection until encountering light turning features 303 such as facets formed on the upper surface 325 of the illumination panel 301. When the artificial light 309 and/or the natural light 311 encounter a light turning feature 303, some of the light 309 and 311 may be redirected towards the bottom surface 323 and pass therethrough. As with the light turning features 203 discussed above with reference to FIGS. 2A and 2B, the light turning features 303 may include any feature configured to turn or extract light propagating within the illumination panel 301 and the light turning features 303 may be formed by a variety of techniques.

Still referring to FIG. 3B, the artificial light 309 and the natural light 311 are emitted from the lower surface 323 of the illumination panel 301 as a composite output light 313. As with the illumination system 200 of FIGS. 2A and 2B and the other illumination systems disclosed herein, certain characteristics of the output light 313 (for example, color and/or intensity) can depend on the characteristics of the artificial light 309 and the natural light 311 that are input into the illumination panel and form the output light 313. For example, in some implementations, a color characteristic of the output light 313 will be a combination of color characteristics of the natural light 311 and the artificial light 309.

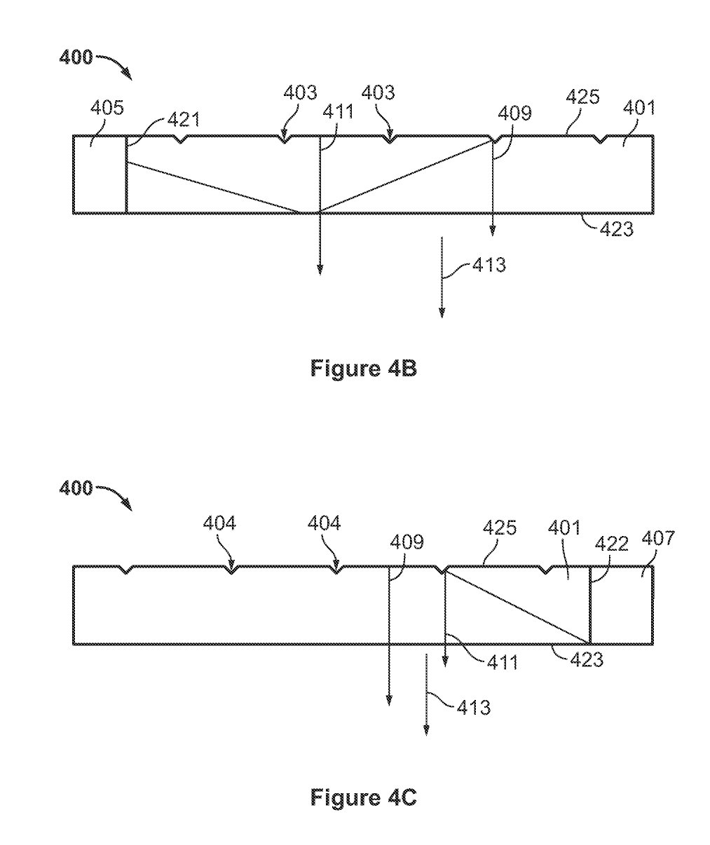

FIG. 4A shows a perspective view of an example of an illumination panel with natural and artificial light inputs. FIG. 4B shows a side view of the illumination panel of FIG. 4A. FIG. 4C shows another side view of the illumination panel of FIG. 4A. In some implementations, the illumination panel 401 can be configured to emit an output light 413 in one or more directions and can include similar materials and can be similarly sized and shaped to the illumination panel 201 discussed above with reference to FIGS. 2A and 2B. The illumination panel 401 can be configured to be optically coupled to one or more natural light collection systems 407 and to one or more artificial light systems 405.

The illumination system 400 includes an artificial light system 405 that is optically coupled to a first edge 421 of the illumination panel 401. The illumination system 400 also includes a natural light collection system 407 that is optically coupled to a second edge 422 of the illumination panel 401. In the example illustrated in FIG. 4A, the first edge 421 is disposed orthogonal to the second edge 422. The artificial light system 405 can provide artificial light 409 into the illumination panel 401 through the first edge 421 of the illumination panel 401. The natural light collection system 407 can provide natural light 411 into the illumination panel 401 through the second edge 421 of the illumination panel 401.

As schematically illustrated in FIGS. 4B and 4C, artificial light 409 may propagate through the illumination panel 401 away from the first edge 421 towards an opposite edge and natural light 411 may propagate through the illumination panel 401 away from the second edge 422 towards an opposite edge. The illumination panel 401 is configured such that the artificial light 409 and the natural light 411 may reflect within the illumination panel 401 one or more times between the upper surface 425 and the bottom surface 423 of the illumination panel until the light turning features 403 redirect some of the light 409 and 411 at such an angle towards the bottom surface 423 that the light passes therethrough.

In this implementation, the illumination panel 401 can include at least a first set of turning features 403 and a second set of turning features 404. As shown in FIG. 4A, the first set of turning features 403 can extend across the upper surface 425 of the illumination panel 401 perpendicular to the second set of turning features 404. In this way, the first set of turning features 403 can be positioned to redirect the artificial light 409 introduced into the illumination panel 401 through the first edge 421 and the second set of turning features 404 can be positioned to redirect the natural light 411 introduced into the illumination panel through the second edge 422, as illustrated in FIGS. 4B and 4C. Thus, each set of turning features 403 and 404 can be configured to redirect light or extract light that has entered the illumination panel 401 from one of the two adjacent perpendicular edges 421 and 422.

As with the light turning features 203 discussed above with reference to FIGS. 2A and 2B, the light turning features 403 and 404 can include any feature configured to turn or extract light propagating within the illumination panel 401. Although illustrated in FIGS. 4B and 4C as v-shaped grooves, the light turning features 403 and 404 can include various light turning features that are cut or embossed into the upper surface 425 of the illumination panel 401. For example, the light turning features 403 and 404 can include grooves (e.g., v-shaped grooves and/or curvilinear shaped grooves), pits, dots, prismatic features, dimples, truncated cones, etc. In some implementations, the first set of light turning features 403 can include different features than the second set of light turning features 404. For example, the first set of light turning features 403 can include v-shaped grooves specifically configured to redirect artificial light and the second set of light turning features 404 can include cones, dimples, and/or dots specifically configured to redirect natural light. In another example, a regular or irregular array of truncated cone indentations into a surface of illumination panel 401 serves as light-turning features 404. These truncated cones may be metalized locally to enhance their light-turning capability.

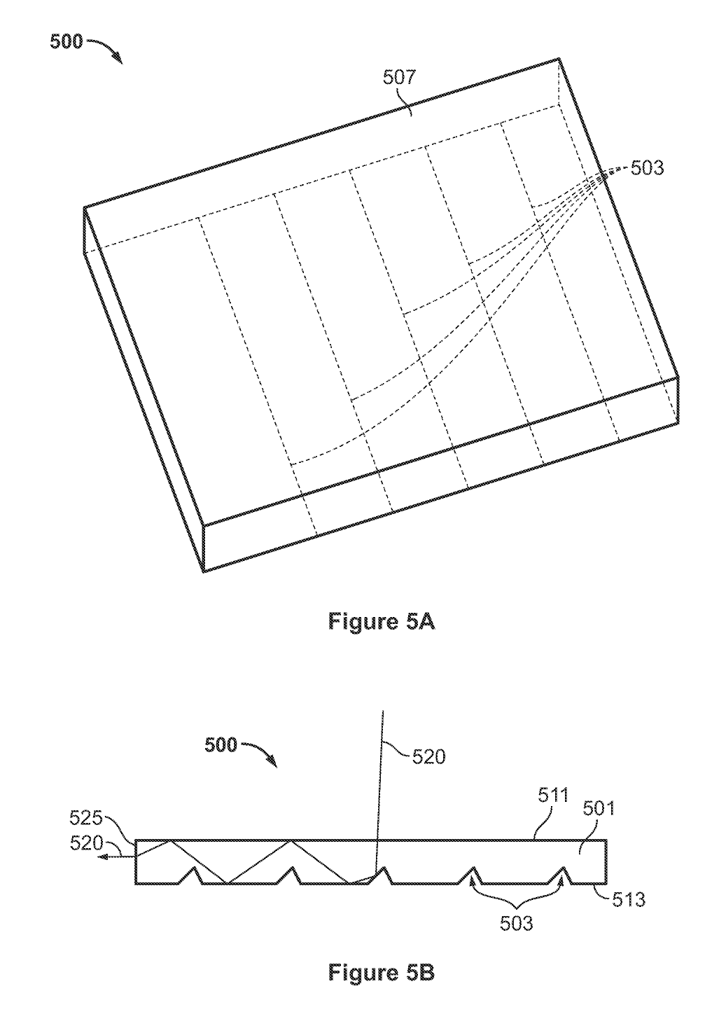

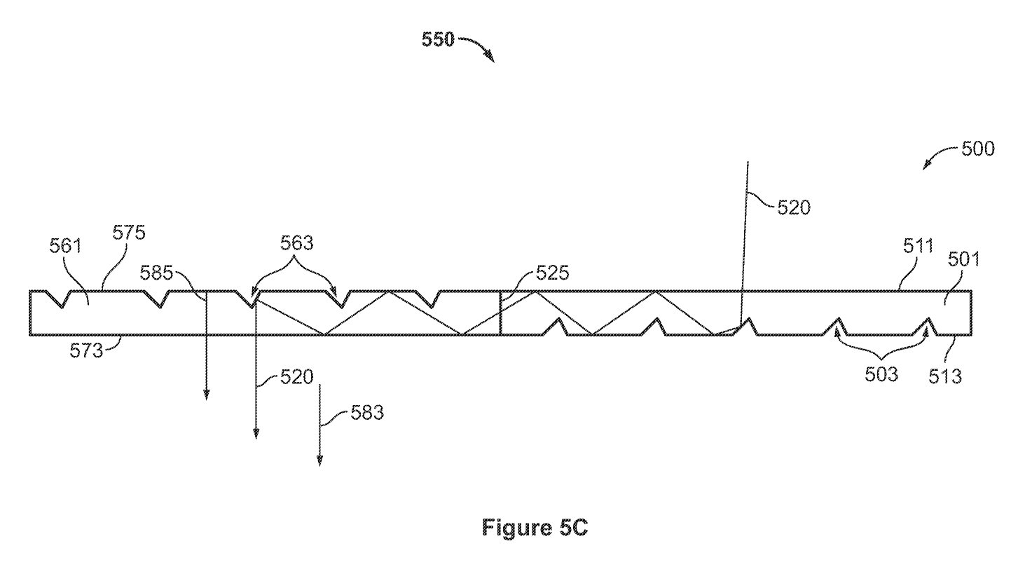

FIG. 5A shows a perspective view of an example of a natural light collection system that can be incorporated in an illumination system with, for example, the illumination panels illustrated in FIGS. 1-4C. FIG. 5B shows a side view of the natural light collection system of FIG. 5A. The natural light collection system 500 of FIGS. 5A and 5B includes a light guide 507 having a set of light gathering features 503. The light guide 507 includes an upper planar surface 511, a lower surface 513, and a set of edges disposed therebetween. The light guide 501 may be formed of at least one rigid or a semi-rigid optically transmissive material, such as glass or acrylic, so as to provide structural stability to the natural light collection system 500. In other implementations, the light guide 501 may be formed of at least one flexible material such as a flexible polymer. Other materials, for example, polymethylmethacrylate, polyethylene terephthalate, or cyclo-olefin polymer may be used for the light guide 501 in other implementations. In some implementations, the light guide 501 may include a substantially hollow center with air or other gas(es) as the primary light transmission medium.

As shown in FIG. 5B, the upper surface 511 of the light guide 501 is configured to receive natural ambient light 520. In some implementations, the length and width of the light guide 501 may be substantially greater than the thickness of the light guide 501. The thickness of the light guide 501 may vary from about 0.1 mm to 10 mm. The area of the light guide 501 may vary from about 0.01 to 1000 cm². Dimensions outside these ranges are also possible. In some implementations, the refractive index of the material(s) forming the light guide 501 may be higher than the surrounding material so as to guide a large portion of the ambient light 520 within the light guide 501 by total internal reflection. In some implementations, the light guide 501 may be formed of any material with an index of refraction that is greater than 1.0.

Light guided in the light guide 501 may suffer losses due to absorption in the light guide 501 and scattering from other facets. To reduce such losses, the light guide 501 can include a thin reflective coating on surfaces that are not used to input or output light. In some implementations, an optical coating (e.g., an anti-reflection coating or an index matching layer) may be deposited on an input or output surface (e.g., upper surface 511 and side surface 525) of the light guide 501 to reduce losses.

In other implementations, the light gathering features 503 are disposed on the upper surface 511 (not shown). Light gathering features 503 can include any feature configured to turn or reflect light, for example, refractive features, dots, grooves, pits, truncated cones, prismatic features, holograms, or diffractive gratings. In some implementations, light gathering features 503 can be disposed on a film which may be laminated on the upper and/or lower surfaces 511 and 513 of the light guide 501.

As shown in FIG. 5B, the light guide 501 is configured to allow light 520 that is incident on the light guide 501 to pass through the upper surface 511 toward the lower surface 513. Light 520 can be redirected into the light guide 501 by the light gathering features 503 disposed on the lower surface 513. The redirected natural light propagates within the light guide 501 to an output port (or edge) 525 of the light guide 501. The natural light collection system 500 can be optically coupled to an illumination panel.

FIG. 5C shows a side view of an example of an illumination system including the natural light collection system of FIG. 5B and an illumination panel. The illumination panel 561 may be similar to the illumination panels of FIGS. 2A-4C. In some implementations, the illumination panel 561 receives the natural light 520 through the output port 525 of the natural light collection system 500. Once introduced into the illumination panel 561, the natural light 520 reflects within the illumination panel 561 between the upper surface 575 and the bottom surface 573 of the illumination panel 561 until the light turning features 563 of the illumination panel 563 redirect some of the light 520 at such an angle towards the bottom surface 573 that the light passes therethrough. The illumination panel 561 may optionally be coupled to one or more other sources of light (e.g., natural light collection systems and/or artificial light systems) which input light 585 into the illumination panel 561. In this way, the illumination system 550 can output light 583 including the natural light 520 provided by the natural light collection system 500 and any other light received by the illumination panel 561. A light-guide extender (not shown) without facets or other light-turning features may be positioned between light guide 501 that collects light and illumination panel 561 that emits light.

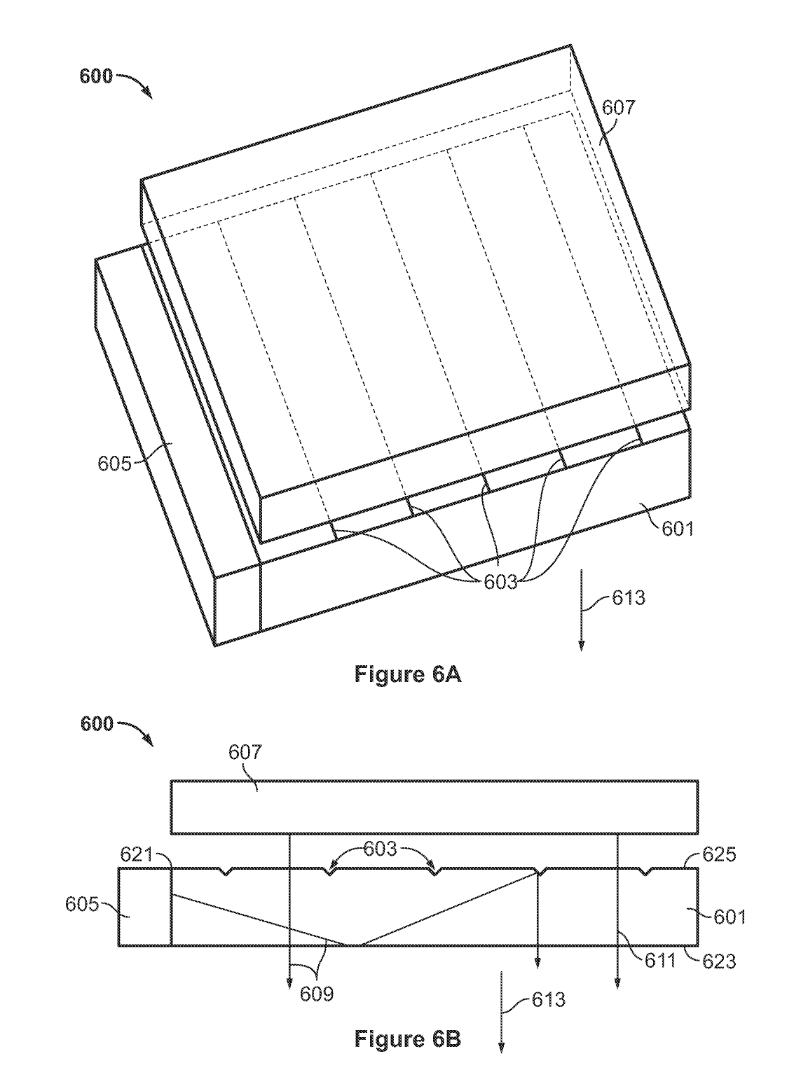

FIG. 6A shows a perspective view of a natural light collection system optically coupled to an illumination panel in an example of an illumination system. FIG. 6B shows a side view of the illumination system of FIG. 6A. The illumination system 600 includes an illumination panel 601, an artificial light system 605 optically coupled to an edge 621 of the illumination panel 601, and a natural light collection system 607 that is optically coupled to an upper surface 625 of the illumination panel 601. In some implementations (as illustrated here), the edge 621 that receives artificial light can be disposed orthogonal to the upper surface 625. The artificial light system 605 can include one or more sources of artificial light, and provides artificial light 609 into the illumination panel 601 through the edge 621 of the illumination panel 601. The natural light collection system 607 is configured to provide natural light 611 into the illumination panel 601 through the upper surface 625 of the illumination panel 601.

As illustrated in FIG. 6B, the illumination panel 601 is configured such that artificial light 609 can propagate through the illumination panel 601 away from the edge 621 and natural light 611 can propagate through the illumination panel 601 from the upper surface 625 toward a lower surface 623. When the artificial light 609 encounters a light turning feature 603, at least some of the artificial light 609 is redirected toward the bottom surface 623 and extracted therethrough. In this configuration, natural light 611 passes through the illumination panel 601 and is emitted from the lower surface 623 of the illumination panel 601 as composite output light 613. The illumination panel 601 can include an anti-reflective coating on the surface 625 facing the natural light collection system 607 for improved optical coupling.

FIG. 7A illustrates a perspective view of an example of an illumination system with natural and artificial light inputs. FIG. 7B shows a side view of the example illumination system of FIG. 7A. In this example, the illumination system 700 includes an illumination panel 701 that is configured to output light 713 in one or more directions. In some implementations, the illumination panel 701 can include similar materials and can be similarly sized and shaped to the illumination panel 201 discussed above with reference to FIGS. 2A and 2B. However, in contrast to the illumination panel 201 discussed above with reference to FIGS. 2A and 2B, the illumination panel 701 need not include light turning features.

The illumination system 700 of FIG. 7A includes an artificial light system 705 disposed adjacent to, and optically coupled to, an upper surface 725 of the illumination panel 701. The illumination system 700 also includes a natural light collection system 707 disposed adjacent to the artificial light system 705 such that the artificial light system 705 is between the natural light collection system 707 and the illumination panel 701. The natural light collection system 707 is also optically coupled to the upper surface 725 of the illumination panel 701. The artificial light system 705 is configured to provide artificial light 709 into the illumination panel 701 through the upper surface 725 of the illumination panel 701. The natural light collection system 707 is configured to provide natural light 711 into the illumination panel 701 through the upper surface 725 of the illumination panel 701. In some alternative implementations, the position of the artificial light system 705 and the natural light collection system 707 are switched. In either case, the light system disposed adjacent to the illumination panel 701 is substantially transmissive such that light emitted by the other of the artificial light system 705 and/or natural light collection system 707 may pass therethrough. In an alternative implementation, an artificial light system and a natural light system are disposed as illustrated in FIGS. 7A and 7B (or their placements are reversed) without an illumination panel in the system.

As illustrated in FIG. 7B, artificial light 709 may pass through the upper surface 725 of the illumination panel 701 and may exit the lower surface 723. Similarly, natural light 711 may pass through the upper surface 725 and may exit the lower surface 723 of the illumination panel 701. The artificial light 709 and the natural light 711 that are emitted from the lower surface 723 of the illumination panel 701 form a composite output light 713.

FIG. 8 shows a side view of an example of a natural light collection system of an illumination system. The natural light collection system 800 of FIG. 8 is configured to receive natural light and to guide the natural light to an illumination panel or to a light guide that is coupled to an illumination panel. For example, the natural light collection system 800 can be incorporated in the example illumination systems of FIGS. 6A-7B. The natural light collection system 800 can include a light tube 801 that is configured to receive ambient light through a first end 821. The illustrated light tube 801 is cylindrical, however in other implementations, the light tube 801 can instead have a polygonal cross-sectional shape (e.g., square or rectangular). The light tube 801 can be straight (as illustrated) or at least partially curved to facilitate routing of the natural light. Right elbows or other angled transition regions (not shown) may be included in light tube 801. The ambient light received in the first end 821 of the light tube 801 may be reflected within the light tube 801 and may propagate towards a second end 823. The inner surface of the light tube 801 can be coated with a reflective coating and/or the light tube 801 may be formed of a reflective material to reduce losses of the ambient light due to absorption and/or scattering. The light tube 801 is configured to direct light through the second end 823 exiting as output light 811. The light tube 801 may be optically coupled to an illumination panel such that the output light 811 is introduced into and then can be emitted from the illumination panel. In some implementations, the light tube 801 may be disposed over an upper surface of an illumination panel such that the output light 811 passes straight through the illumination panel. Alternatively, the light tube 801 may be optically coupled to an edge or other input port of an illumination panel.

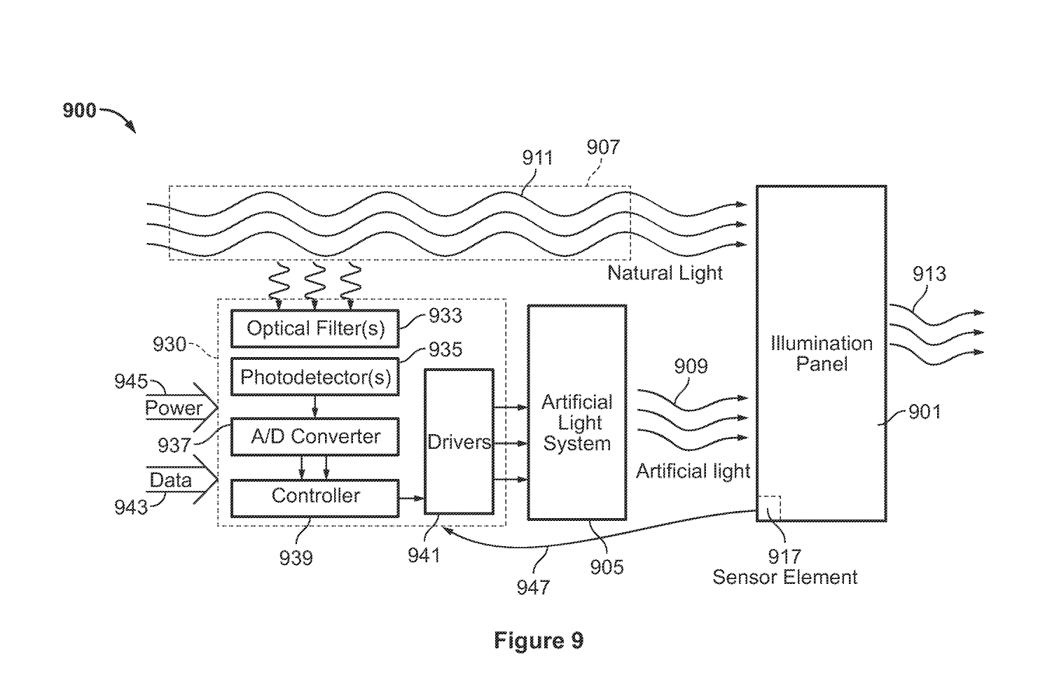

FIG. 9 shows an example of a system diagram of an illumination system with a natural light input, an artificial light input, and a control system that can vary the artificial light input based at least in part on the natural light input. The illumination system 900 includes an illumination panel 901 that is optically coupled to a natural light collection system 907 and an artificial light system 905. The illumination panel 901 can be configured to receive artificial light 909 from the artificial light system 905 and/or natural light 911 from the natural light collection system 907. The illumination panel 901 is configured to provide an output light 913 through one or more output ports, the output light 913 including received artificial light 909 and natural light 911. In some implementations, the illumination panel 901 can include similar materials and can be similarly sized and shaped to the illumination panel discussed above with reference to FIGS. 2A-4C, 6A-6B, and 7A-7B.

In some implementations, the illumination system 900 can also include a control system 930. The control system 930 includes a controller 939 for controlling the light emitted by the illumination panel 901, one or more optical filters 933, one or more photodetectors 935, one or more analog-to-digital converters 937, one or more drivers 941, and a power source 945 to operate the components of the illumination system 900. The control system 930 can also include sensors and data input ports. In some implementations, the control system 930 includes a processor, memory, and an interface device. The control system 930 can be configured to control and/or adjust one or more characteristics of the artificial light 909 (e.g., a light intensity characteristic and/or a color characteristic). The one or more optical filters 933 can be optically coupled to the natural light collection system 907 and are configured to receive a portion of the natural light 911 that is also received by the illumination panel 901. Each filter 933 can be optically coupled to the photodetectors 935. Signals from the photodetectors 935 are provided to the analog-to-digital converter 937, and digital signals are provided by the analog-to-digital converter 937 to the controller 939. The controller 939 is configured to control one or more drivers 941 to drive the artificial light system 905 to provide the desired amount of light having the desired characteristics. In some implementations, the controller includes a program that performs operations to control the illumination panel 901 light output based on the signals generated by the optical filters, or signals generated from a sensor 917 that senses the output of the illumination panel 901 (described further below).

The controller 939 can be configured to adjust a color and/or intensity characteristic of the artificial light 909 that is output by the artificial light system 905 based on the natural light 911. For example, if an intensity characteristic of the natural light 911 is relatively low, the control system 930 can increase an intensity characteristic of the artificial light 909 such that an intensity characteristic of the output light 913 is at or above a desired value. This allows for the control of the intensity of the artificial light 909 to supplement the natural light 911 and thus allows for a control of the intensity of the output light 913. Further, a color characteristic of the artificial light 909 can be adjusted based on a color characteristic of the natural light 911 to produce a desired color characteristic of the output light 913, for example, such that the output light 913 is a white or whitish light when the natural light 911 is red or reddish (e.g., at dusk). In this way, the natural light 911 and artificial light 909 can be monitored for intensity and color, allowing for the artificial light 909 to be tailored for an overall consistency of output light intensity level and color constituency. Other characteristics of the natural light 911 and the artificial light 909 can be monitored and adjusted accordingly in different implementations.

In some implementations, the control system 930 is configured to receive a signal 947 from a sensor element 917 on or near the illumination panel 901, via a wired or wireless connection. The signal 947 may include information of one or more characteristics of the output light 913 (e.g., intensity, color). The control system 930 is configured to process the signal 947 and adjust one or more characteristics of the artificial light 909 based at least in part on the signal 947. For example, if a certain color characteristic of the output light 913 is desired, the control system 930 may adjust the color of the artificial light 909 to result in the desired output light 913 characteristic. Similarly, if a certain intensity characteristic of the output light 913 is desired, the control system 930 may adjust the intensity of the artificial light 909 to result in the desired output light 913 characteristic. In some implementations, the sensor element 917 can also sense the color and/or intensity of ambient light and provide this information to the control system 930. As discussed in more detail below, in one implementation, the control system 930 can measure the intensity of the natural light 911 during an off-period of the artificial light system 905 and measure the intensity of the artificial light 909 during an on-period of the artificial light system 905. Based on these measurements, the control system 930 modulates the artificial light system 905 to produce a desired intensity of the output light 913 based on available natural light 911, ambient light, controller input, and control settings.

In some implementations, the control system 930 may receive data (or information) 943 that causes the control system 930 to perform an action. For example, to set one or more characteristics of the artificial light 909 to certain settings regardless of the amount or color of the natural light 911. For example, a user may provide data 943 to the control system to manually or automatically set the intensity of the artificial light 909 to a maximum value in order to maximize the intensity of the output light 913 regardless of the intensity of the natural light 911 that is received by the illumination panel 901.

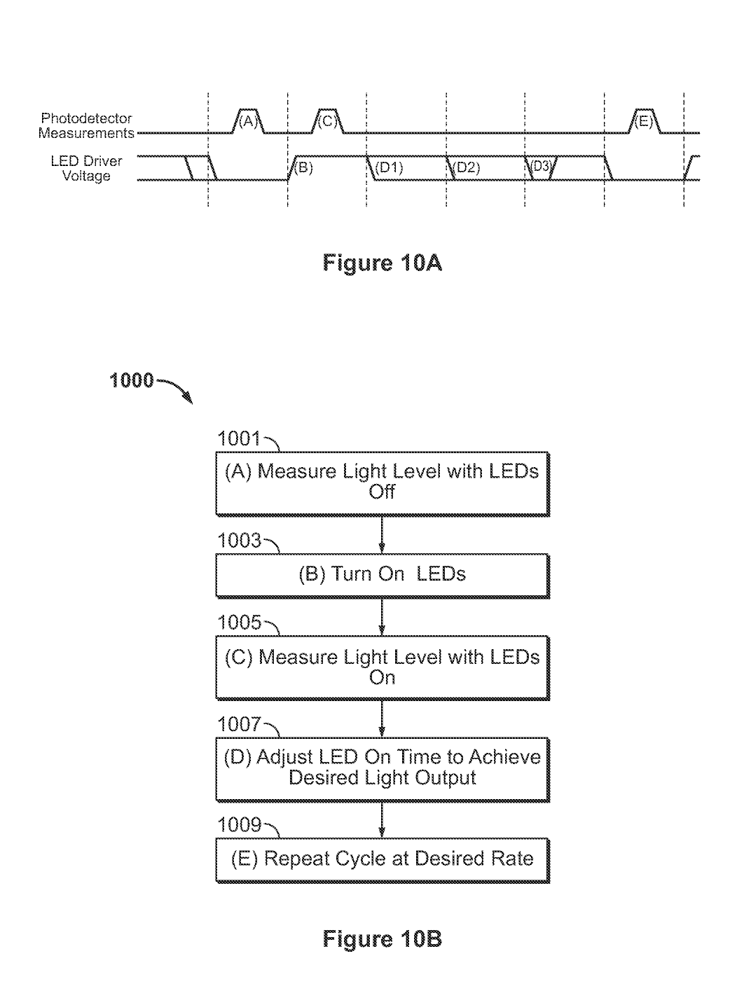

FIG. 10A shows an example timing diagram for balancing inputs of light in an illumination system with natural and artificial light inputs. Pulse width modulation (“PWM”) may be used to provide “breaks” in the output of an artificial light system and these breaks can be used for sensing or detecting light (e.g., with LED light sources having steep electrical inputs to light output response curves). PWM can be used to balance the light intensity and/or color of an artificial light system with a source of natural light (e.g., a natural light collection system) to achieve a desired overall light intensity output and/or overall color. FIG. 10B shows an example flow diagram of a process for balancing inputs of light in an illumination system with natural and artificial light inputs. For clarity, the timing diagram of FIG. 10A and the flow diagram of FIG. 10B are illustrated in the context of an LED artificial light system. However, a person having ordinary skill in the art will appreciate that these diagrams can be implemented in other contexts, for example, with other artificial light systems which may be pulse width modulated.

The process 1000 of FIG. 10B includes blocks that correspond to the timing diagram of FIG. 10A. The correspondence of the blocks in FIG. 10B with the diagram of FIG. 10A is schematically illustrated by the use of letters within parenthesis (e.g., (A):(A), (B):(B), (C):(C), (D):(D1), (D):(D2), (D):(D3), and (E):(E)). As shown in block 1001, the process 1000 begins by measuring with a photodetector an output light level with the LEDs of the artificial light system off. In some implementations, block 1001 may be omitted and an externally provided set point can be used to determine the LED on times. The process 1000 continues at block 1003 by turning on the LEDs and at block 1005 by measuring the light level or intensity with the LEDs on. In some implementations, block 1005 may be omitted and an externally provided set point and factory calibration data can be used to determine the LED on times. The process continues at block 1007 by adjusting an on time of the LEDs to achieve a desired light intensity. The LEDs may be on for a controlled period of time before being turned off to achieve a desired light output level, for example, a short time D1 for low output light levels, a medium time D2 for medium output light levels, or an extended time D3 for higher output light levels. The process 1000 concludes at block 1009 by repeating the cycle of blocks 1001-1007 at a desired rate. The LEDs are generally turned on and off at a rate sufficiently high to avoid the appearance of flickering. In some implementations, repetitions of the process 1000 schematically illustrated in FIG. 10B need not require block 1001 in each instance as the base measurement can be processed once every few seconds or longer.

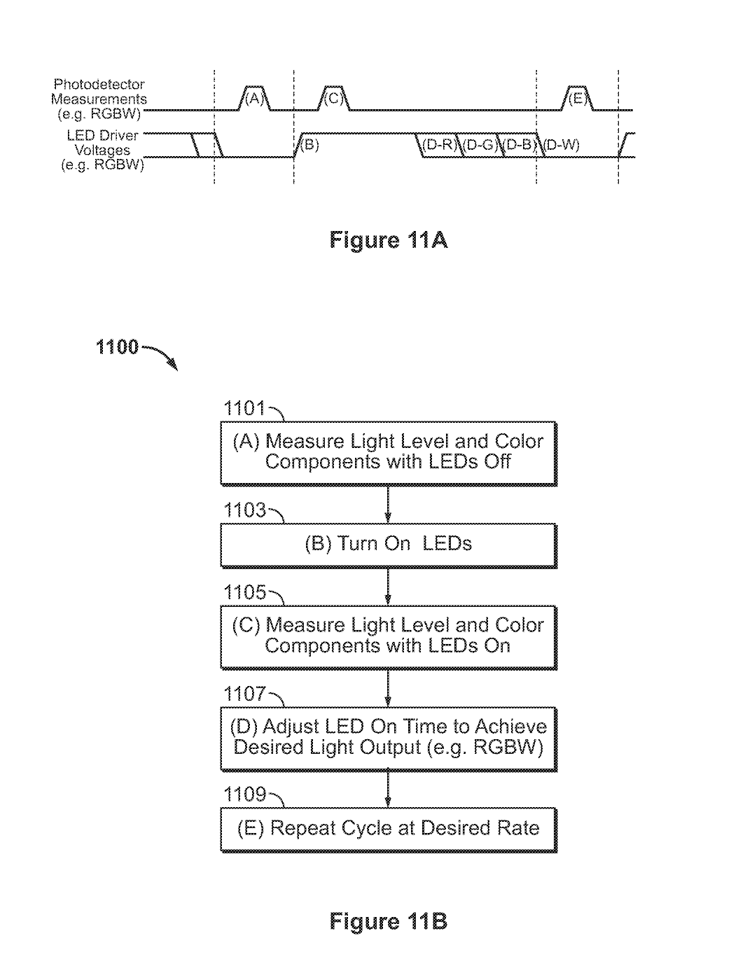

FIG. 11A shows an example timing diagram for balancing inputs of light in an illumination system with natural and artificial light inputs. FIG. 11B shows an example flow diagram of a process for balancing inputs of light in an illumination system with natural and artificial light inputs. For clarity, the timing diagram of FIG. 11A and the flow diagram of FIG. 11B are illustrated in the context of an LED artificial light system. However, a person having ordinary skill in the art will appreciate that these diagrams can be implemented in other contexts, for example, with other artificial light systems that may be pulse width modulated.

The process 1100 of FIG. 11B includes blocks that correspond to the timing diagram of FIG. 11A. The correspondence of the blocks in FIG. 11B with the diagram of FIG. 11A is schematically illustrated by the use of letters within parenthesis (e.g., (A):(A), (B):(B), (C):(C), (D):(D-R), (D):(D-G), (D):(D-B), (D):(D-W), and (E):(E)). As shown in block 1101, the process 100 begins by measuring with one or more photodetectors an output light level, or output light level and color components of the output light with the LEDs of the artificial light system off. In some implementations, block 1101 may be omitted and an externally provided set point can be used to determine the LED on times. The process 1100 continues at block 1103 by turning on the LEDs and at block 1105 by measuring the output light level or output and color components with the LEDs turned on. In some implementations, block 1105 may be omitted and an externally provided set point and factory calibration data can be used to determine the LED power-on times. The process continues at block 1107 by adjusting an on time of each LED to achieve a desired output light color and/or intensity. As shown in FIG. 11A, the example artificial light system can include multiple colors of LEDs, for example, red, green, blue, and white. In the example shown, red, green, blue, and white LEDs are turned on at the same time (B), then turned off after a controlled time as indicated by (D-R), (D-G), (D-B) and (D-W), respectively, to achieve the desired intensity and color constituency. The process 1100 concludes at block 1109 by repeating the cycle of blocks 1101-1107 at a desired rate. In some implementations, repetitions of the process 1100 schematically illustrated in FIG. 11B need not require block 1101 in each instance as the base measurement can be processed once every few seconds or longer.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the illumination systems as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system comprising:
a natural light collection system;
an artificial light system;
an illumination panel including a first light input port optically coupled to the natural light collection system and a second light input port optically coupled to the artificial light system, wherein the illumination panel receives natural light from the natural light collection system through the first light input port and receives artificial light from the artificial light system through the second light input port, the illumination panel further including a light output port; and
a control system including at least one data input port, the control system being coupled to the artificial light system and configured to control a characteristic of the artificial light based on at least one signal received by the at least one data input port.

2. The illumination system of claim 1, wherein the illumination panel includes a first surface, a second surface opposite the first surface, a first edge disposed between the first surface and the second surface, and a second edge disposed between the first surface and the second surface.

3. The illumination system of claim 2, wherein the first edge includes the first light input port.

4. The illumination system of claim 3, wherein the first edge includes the second light input port.

5. The illumination system of claim 3, wherein the second edge includes the second light input port.

6. The illumination system of claim 5, wherein the second edge is disposed on an opposite side of the illumination panel than the first edge.

7. The illumination system of claim 5, wherein the second edge is disposed orthogonal to the first edge.

8. The illumination system of claim 3, wherein the first surface includes the second light input port.

9. The illumination system of claim 2, wherein the first surface includes the first light input port.

10. The illumination system of claim 9, wherein the first surface includes the second light input port.

11. The illumination system of claim 1, wherein a light that passes through the output port includes at least a portion of the natural light.

12. The illumination system of claim 11, wherein the light that passes through the output port includes at least a portion of the artificial light.

13. The illumination system of claim 1, wherein a light that passes through the output port includes at least a portion of the artificial light.

14. The illumination system of claim 1, wherein the control system receives the at least one signal from the natural light collection system.

15. The illumination system of claim 14, wherein the at least one signal corresponds to a color characteristic of the natural light.

16. The illumination system of claim 15, wherein the control system controls a color characteristic of the artificial light.

17. The illumination system of claim 14, wherein the at least one signal corresponds to an intensity characteristic of the natural light.

18. The illumination system of claim 17, wherein the control system controls an intensity characteristic of the artificial light.

19. The illumination system of claim 1, wherein the control system receives the at least one signal from the illumination panel.

20. The illumination system of claim 19, wherein the at least one signal corresponds to a color characteristic of the natural light.

21. The illumination system of claim 20, wherein the control system controls a color characteristic of the artificial light.

22. The illumination system of claim 19, wherein the at least one signal corresponds to an intensity characteristic of the natural light.

23. The illumination system of claim 22, wherein the control system controls an intensity characteristic of the artificial light.

24. The illumination system of claim 2, wherein the illumination panel includes a plurality of light extraction features configured to extract light propagating within the illumination panel into the light output port.

25. The illumination system of claim 1, wherein the natural light collection system includes a light guide having a plurality of light gathering features.

26. A method comprising:
providing an illumination system including a natural light collection system, an artificial light system, and an illumination panel configured to receive natural light from the natural light collection system and artificial light from the artificial light system, the illumination panel also configured to emit an output light;
receiving data on a first characteristic of the natural light or the artificial light; and
adjusting a second characteristic of the artificial light based at least in part on the first characteristic.

27. The method of claim 26, wherein the first characteristic corresponds to an intensity of the natural light.

28. The method of claim 27, wherein the second characteristic corresponds to an intensity of the artificial light.

29. The method of claim 26, further comprising receiving data on a third characteristic of the natural light or the artificial light.

30. The method of claim 29, further comprising adjusting a fourth characteristic of the artificial light based at least in part on the third characteristic.
